(19) United States
(12) Patent Application Publication
(10) Pub. No.: US 2021/0337075 A1
(43) Pub. Date: Oct. 28, 2021

(54) Image Forming Device, Charging Method and Non-Transitory Recording Medium

(71) Applicant: KONICA MINOLTA, INC., Tokyo (JP)

(72) Inventor: Teppei NAKAMURA, Toyokawa-shi (JP)

(73) Assignee: KONICA MINOLTA, INC., Tokyo (JP)

(21) Appl. No.: 17/220,108

(22) Filed: Apr. 1, 2021

(30) Foreign Application Priority Data
Apr. 22, 2020 (JP) 2020-075877

(51) Int. Cl. H04N 1/00; H04N 1/44; G06K 9/00; H04N 1/34

(52) U.S. Cl. CPC H04N 1/00204; H04N 1/442; G06K 9/00288; H04N 1/4426; G06K 9/00624; H04N 2201/0036; H04N 1/4433; H04N 1/346; H04N 2201/0094; H04N 2201/0096; H04N 1/00251

(57) ABSTRACT

An image forming device includes a hardware processor that: receives a charging job that is an object of charging; searches for a charging information storage that is around the device when the charging job is received; obtains charging information from the searched charging information storage; carries out a charging process for the charging job based on the charging information; and processes the charging job after the charging process is carried out.

Japanese patent application No. 2020-075877 filed on Apr. 22, 2020 including description, claims, drawings, and abstract the entire disclosure is incorporated herein by reference in its entirety.

### BACKGROUND

### Technological Field

The present invention relates to an image forming device, a charging method, and a non-transitory recording medium.

### Description of the Related Art

Conventional image forming devices such as MFPs (Multifunction Peripherals) that carries out a charging process to users when the users use the image forming devices to process jobs to be charged including print jobs and copy jobs have been known. This known technique is introduced, for example, in Japanese Patent Application Laid-Open No. JP 2007-48188 A (hereafter, conventional patent document). The conventional image forming devices described in the conventional patent document, for example, is put into a waiting state for the job processing once it receives the print job from the user. When the user holds a contactless device such as a smartphone in which electronic money information is stored on the image forming device at the time that the image forming device is in the waiting state for the job processing, the image forming device automatically collects the electric money from the contactless device. The waiting state for the job processing is released, and the image forming device starts producing a printed output.

In order to use the conventional image forming device as described above, the user needs to hold the contactless device such as the portable device on the image forming device which is not convenient. The user, for instance, may carry baggage in both hands. For holding the portable device on the image forming device under such a circumstance, the user needs to put the baggage on the floor and take the portable device out from his or her pocket, then hold the portable device on the image forming device. To be more specific, the user cannot use the image forming device while carrying the baggage so it is bothersome.

### SUMMARY

One or more embodiments provide an image forming device, a charging method and a non-transitory recording medium that are enabled to automatically carry out an appropriate charging process without any user operation.

In one aspect, the present invention is directed to an image forming device.

According to an aspect of the present invention, the image forming device comprises a hardware processor that: receives a charging job that is an object of charging; searches for a charging information storage that is around the device when the charging job is received; obtains charging information from the searched charging information storage; carries out a charging process for the charging job based on the charging information; and processes the charging job after the charging process is carried out.

In another aspect, the present invention is directed to a charging method applied in an image forming device.

According to an aspect of the present invention, the charging method comprises: receiving a charging job that is an object of charging; searching for a charging information storage that is around the device when the charging job is received; obtaining charging information from the searched charging information storage; carrying out a charging process for the charging job based on the charging information; and processing the charging job after the charging process is carried out.

In another aspect, the present invention is directed to a non-transitory recording medium storing a computer readable program to be executed by a hardware processor in an image forming device.

According to an aspect of the present invention, the non-transitory recording medium stores the computer readable program, execution of the computer readable program by the hardware processor causing the hardware processor in the image forming device to perform: receive a charging job that is an object of charging; search for a charging information storage that is around the device when the charging job is received; obtain charging information from the searched charging information storage; carry out a charging process for the charging job based on the charging information; and process the charging job after the charging process is carried out.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an exemplary structure of an image forming device in which a first embodiment of the present invention may be practiced;

FIG. 2 illustrates a block diagram showing an exemplary hardware structure of the image forming device;

FIG. 3 illustrates an example of user information;

FIG. 4 illustrates an example of terminal information;

FIG. 5 illustrates a block diagram showing an example of the functional structure of the image forming device;

FIG. 6 illustrates a block diagram showing an exemplary hardware structure and functional structure of a portable terminal;

FIG. 7 illustrates an exemplary main flow of the cooperation operation between the image forming device and the portable terminal;

FIG. 8 illustrates an example of a flow diagram explaining an exemplary procedure of the process performed in the image forming device;

FIG. 9 illustrates a flow diagram explaining an exemplary procedure of a print job controlling process of the first embodiment in detail;

FIG. 10 illustrates an example the number of a produced printed output when a paid amount does not reach a charging amount in a charging process;

FIG. 11 illustrates an example of a notification screen displayed on a display unit of the image forming device when the charging amount is short;

FIG. 12 illustrates a flow diagram explaining an exemplary procedure of a copy job controlling process of the first embodiment in detail;

FIG. 13 illustrates an exemplary structure of the image forming device in which a second embodiment of the present invention may be practiced;

FIG. 14 illustrates an exemplary main flow of the operations of the image forming device of the second embodiment;

FIG. 15 illustrates a flow diagram explaining an exemplary procedure of the print job controlling process of the second embodiment in detail; and

FIG. 16 illustrates a flow diagram explaining an exemplary procedure of the copy job controlling process of the second embodiment in detail.

### DETAILED DESCRIPTION OF EMBODIMENTS

Hereinafter, embodiments of the present invention will be described with reference to the drawings. However, the scope of the invention is not limited to the disclosed embodiments.

### First Embodiment

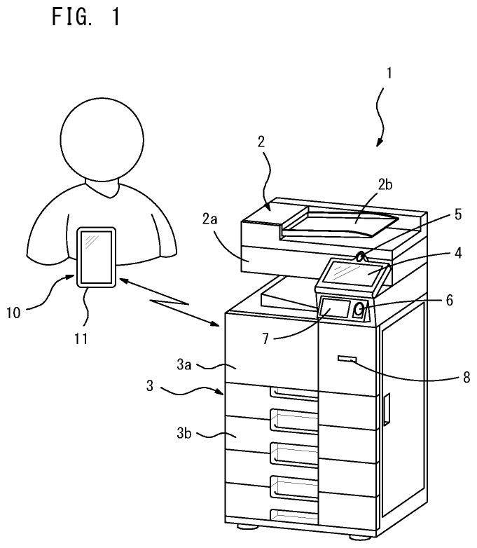

FIG. 1 illustrates an exemplary structure of an image forming device 1 in which the first embodiment of the present invention may be practiced. The image forming device 1 is constructed by one of MFPs, for example, and has functions including a print function, a scan function, and a copy function. The image forming deice 1 is shared by multiple users. The image forming device 1 activates the print function, scan function or the copy function in response to a request from the user and processes a job instructed by the user. The image forming device 1 includes a scanner section 2 in an upper part of the device body and a printer section 3 in a lower part of the scanner section 2. The image forming device 1 is also provided with an operational panel 4 that serves as a user interface on a front side of the device body.

The scanner section 2, for example, includes an image reader 2a and an automatic document carrier 2b. When a document is placed on the automatic document carrier 2b and the user instructs to start scanning, the scanner section 2 brings the automatic document carrier 2b into operation to start an operation to feed the document one by one placed by the user. The scanner section 2 synchronizes according to the operation of the automatic document carrier 2b and brings the image reader 2a into operation. The scanner section 2 enables the image reader 2a to read an image of the document when the document carried by the automatic document carrier 2b passes through a predetermined position read by the image reader 2a. The scanner section 2 then generates image data of the document. When the user instructs the processing of the scan job or the copy job, the scanner section 2 reads the image of the document placed by the user and generates the image data.

The printer section 3 includes an image forming unit 3a and a feeding unit 3b. When the processing of the print job or the copy job is instructed by the user, the printer section 3 brings the feeding unit 3b and the image forming unit 3a into operation in cooperation, so that the image is formed on a sheet such as a printing paper and a printed output is produced. When the print job or the copy job is processed, the feeding unit 3b feeds the sheet one by one toward the image forming unit 3a. The image forming unit 3a forms a toner image based on print data on the sheet fed by the feeding unit 3b. The image forming unit 3a then fixes the toner image on the sheet and outputs the sheet. When the multiple printed outputs are produced based on the print job or the copy job, the feeding unit 3b continuously feeds the multiple sheets, and the image forming unit 3a forms the image one after another on the sheet continuously fed by the feeding unit 3b. The image forming unit 3a of the first embodiment uses the toner to form the image. However, this is given not for limitation. The image forming unit 3a may use ink to form the image.

The operational panel 4 displays a variety of operational screens operable for the user who uses the image forming device 1 and receives inputs by the user. A camera 5, a biological information obtaining unit 6 and a card information reader 7 are provided near the operational panel 4. The camera 5 is a photographing mean that can photograph the user who operates the image forming device 1. The biological information obtaining unit 6 reads a finger print pattern or a vein pattern of the user as biological information. The card information reader 7 reads information stored in a storage such as an IC card. The camera 5, the biological information obtaining unit 6 and the card information reader 7 obtain information to be used for authentication of the user, for example. The image forming device 1 is also provided with a person detecting sensor 8 on the front side of the device body. The person detecting sensor 8 is enabled to detect the person who exists within a certain distance at the front side of the image forming device 1. The person detecting sensor 8, for example, is formed from an infrared sensor.

The above-described image forming device 1 receives a job that produces a printed output such as a print job or a copy job, for instance, as a job to be charged (hereafter, charging job). Once the charging job is received, the image forming device 1 runs a search for a charging information storage 10 that is around the device, and obtains charging information in the charging information storage 10. The charging information storage 10 of the first embodiment is constructed by a portable terminal 11 carried by the user. The charging information used to charge the user is stored in the portable terminal 11. The charging information, for example, is an application installed in the portable terminal 11. The charging information contains information relating to a charging application that charges through electric money payment, credit card payment and/or payment of direct withdrawal from a bank account.

Once receiving the charging job, the image forming device 1 runs a search for the portable terminal 11 that is around the device, and obtains the charging information from the portable terminal 11. The image forming device 1 establishes a wireless communication with the portable terminal 11 so that it is enabled to run an automatic search for the portable terminal 11. The image forming device 1 is also enabled to automatically obtain the charging information from the portable terminal 11 which was successfully detected through the search. The image forming device 1 starts the charging application in the portable terminal 11 based on the charging information obtained from the portable terminal 11, and enables the charging application to charge a charging amount required for the processing of the charging job. When the charging application is enabled to charge normally, the image forming device 1 produces a printed output based on the charging job and provides the user with the printed output. The user may put his or her portable terminal 11 in a pocket. Even in such a case, the image forming device 1 is enabled to charge smoothly without asking the user to take the portable terminal 11 out from the pocket. The image forming device 1 is described in detail next.

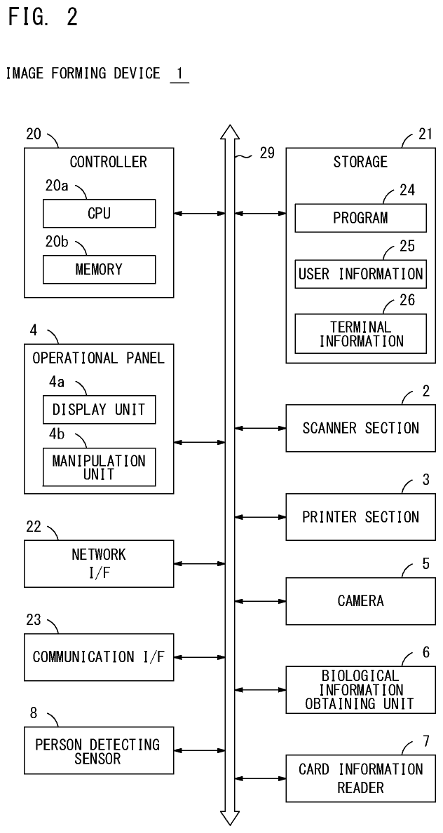

FIG. 2 illustrates a block diagram showing an exemplary hardware structure of the image forming device 1. As its hardware structure, the image forming device 1 is provided with a controller 20, a storage 21, a network interface 22 and a communication interface 23 in addition to the aforementioned scanner section 2, the printer section 3, the operational panel 4, the camera 5, the biological information obtaining unit 6, the card information reader 7 and the person detecting sensor 8.

The operational panel 4 includes a display unit 4a and a manipulation unit 4b. The display unit 4a is constructed by a device such as a color liquid crystal display, for instance. A variety of information is displayed to the user and various kinds of screens operable for the user are displayed on the display unit 4a. The manipulation unit 4b is constructed by a part such as a touch panel key and/or a push-button key. The manipulation unit 4b receives an input by the user. The manipulation unit 4b, for example, receives a job setting operation or a job processing instruction from the user.

The controller 20 controls the overall operation of each part. The controller 20 includes a CPU 20a and a memory 20b. The CPU 20a is a hardware processor that executes a variety of programs. The CPU 20a reads and executes a program 24 stored in the storage 21, for example. The memory 20b stores temporary data generated when the CPU 20a executes the variety of programs.

The storage 21 is formed from a non-volatility device such as a hard disk drive (HDD) or a solid-state drive (SDD), for example. The program 24 which is executed by the CPU 20a is stored in advance in the storage 21. User information 25 and terminal information 26 is also stored in the storage 21.

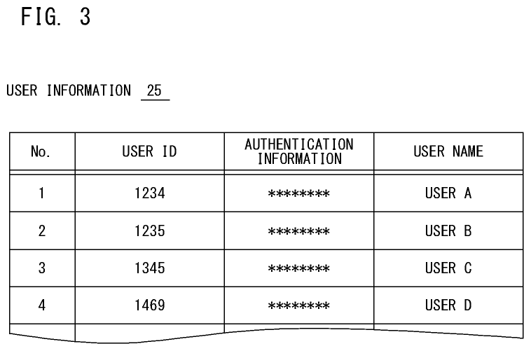

FIG. 3 illustrates an example of the user information 25. Authentication information to authenticate the user who uses the image forming device 1 is registered as the user information 25. The user who is allowed to use the image forming device 1 is registered with the user information 25, for example. A user ID, authentication information and a user name are registered for each user. The user ID is unique identification information assigned to each user. The authentication information is to authenticate each user. The authentication information includes information defining a feature of a face of the user for the face authentication, information defining a feature of a finger print pattern or a vein pattern of the user for the biological authentication and/or information registered in the IC card carried by the user for the card authentication. The authentication information should include at least one of the information for the face authentication, the biological authentication, and the card authentication. Information such as a name of each user is registered as the user name.

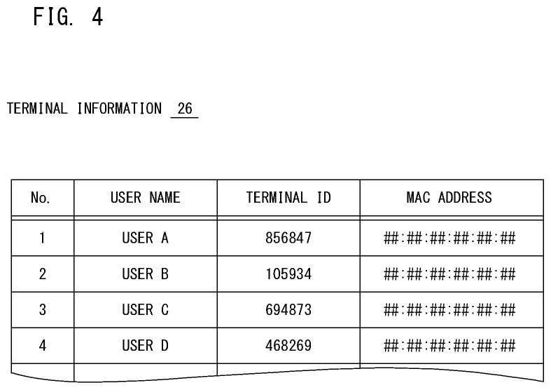

FIG. 4 illustrates an example of the terminal information 26. Information relating to the portable terminal 11 carried by the user is registered as the terminal information 26. As illustrated in FIG. 4, a user name, a terminal ID of the portable terminal 11 and a MAC address of the portable terminal 11 are registered with the terminal information 26. The terminal ID is information to identify the portable terminal 11 carried by the user. The MAC address is also information to identify the portable terminal 11. The MAC address is one of addresses used for communication with the portable terminal 11. As described above, the terminal information 26 makes the user correspondent to the portable terminal 11. The portable terminal 11 carried by each user can be identified by referring to the terminal information 26.

The network interface 22 is an interface that connects the image forming device 1 to a network such as LAN (Local Area Network). The connection to the network may be wired or wireless. An information processing device such as a personal computer used by each user is connected to the network, for example. The image forming device 1 is enabled to receive a print job sent from the information processing device via the network interface 22.

The communication interface 23 is an interface that establishes wireless communication such as Bluetooth (trademark) and/or WiFi, for example. The communication interface 23 automatically establishes a connection with the portable terminal 11 within a predetermined distance of the image forming device 1, and makes the wireless communication. The communication interface 23 may establish a connection with the single portable terminal 11 or connections with multiple portable terminals 11 at the same time.

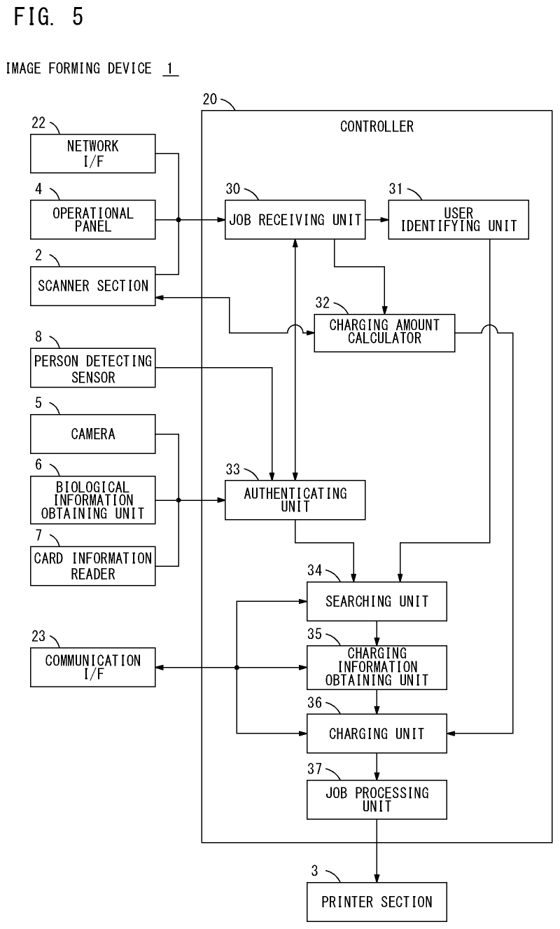

FIG. 5 illustrates a block diagram showing an example of the functional structure of the image forming device 1. The CPU 20a of the controller 20 executes the program 24. The controller 20 then serves as various kinds of processing units. Especially the controller 20 of the first embodiment serves as a job receiving unit 30, a user identifying unit 31, a charging amount calculator 32, an authenticating unit 33, a searching unit 34, a charging information obtaining unit 35, a charging unit 36 and a job processing unit 37.

The job receiving unit 30 receives the job issued by the user. The job receiving unit 30, for example, receives the print job which is received via the network interface 22. After detecting the document is placed on the scanner section 2, the job receiving unit 30 displays a function selecting screen on the operational panel 4. The user may select the copy function. The job receiving unit 30 then accepts a user input relating to a setting of the copy job, and receives the copy job that has the setting configured by the user. When the scan function is selected by the user, the job receiving unit 30 receives the scan job that has a setting configured by the user.

After receiving the job, the job receiving unit 30 determines if the job is a job to be charged. If the job is to be charged, the job receiving unit 30 receives the job as the charging job. The received job may be the print job or the copy job that produces a printed output. In this case, the job receiving unit 30 receives the job as the charging job.

The user identifying unit 31 is brought into operation when the print job is received by the job receiving unit 30. The user identifying unit 31 identifies the user who has issued the print job. The user identifying unit 31 refers to header information of the print job, for instance, to identify the user who issued the job based on the information for identification of the user such the user ID and/or the user name included in the header information.

The charging amount calculator 32 calculates an amount to be charged for the charging job. The charging amount calculator 32 is brought into operation when the charging job is received by the job receiving unit 30. The charging amount calculator 32 calculates a charging amount to be charged to the user for the processing of the charging job. The received job may be the print job, for instance. In this case, the charging amount calculator 32 specifies the number of toner colors and/or the number of sheets to be used for producing the printed output based on the print setting included in the print job. The charging amount calculator 32 then calculates the charging amount based on the numbers of the colors and sheets.

The charging job may be the copy job. In this case, the number of the output sheets can be specified only after completion of the reading operation of the document by the scanner section 2. The charging amount calculator 32 is brought into operation after the start of the operation to read the document is instructed by the user and the reading operation of the document by the scanner section 2 is complete. The charging amount calculator 32 calculates the number of the sheets to be output based on the number of the documents read by the scanner section 2 and the setting of the copy job. The charging amount calculator 32 then calculates the charging amount based on the number of the sheets to be output and the number of the toner colors.

The authenticating unit 33 authenticates the user who is trying to use the image forming device 1 positioned in front of the image forming device 1. The authenticating unit 33 is brought into operation when, for example, the person detecting sensor 8 detects a person within the predetermined distance in front of the image forming device 1. The authenticating unit 33 starts authentication to authenticate the user. There are three ways for the authenticating unit 33 to perform an authentication. The first way of authentication is a face authentication that photographs a face image of the user using the camera 5 and analyzes the face image, thereby authenticating the user. The second way of authentication is a biological authentication that reads biological information such as a finger print pattern and/or a vein pattern of the user through the biological information obtaining unit 6 and authenticates the user based on the biological information. The third way of authentication is a card authentication that reads card information stored in the IC card carried by the user through the card information reader 7 and authenticates the user based on the card information. The authenticating unit 33 performs the authentication of the user using one of the first to the third ways.

When a person is detected around the image forming device 1 by the person detecting sensor 8, for instance, the authenticating unit 33 drives the camera 5 and photographs the face image of the user, and extracts the feature of the face of the user based on the face image. The authenticating unit 33 then determines if the feature of the face of the user matches with feature information of the face registered with the authentication information in the user information 25. The feature of the face of the user extracted based on the face image may match with the feature information of the face registered with the user information 25. In this case, the user who is trying to use the image forming device 1 is identified through the authentication by the authenticating unit 33, and the authentication results in success. The information defining the feature of the face of the user for the face authentication may not be registered with the user information 25. In this case, the user cannot be identified through the face authentication by the authenticating unit 33, and the authentication results in failure.

When the person is detected around the image forming device 1 by the person detecting sensor 8, the authenticating unit 33 brings the biological information obtaining unit 6 into operation and waits for receiving the biological information from the biological information obtaining unit 6. While the authenticating unit 33 is waiting, the biological information obtaining unit 6 may obtain the biological information of the user. The authenticating unit 33 then performs the biological authentication based on the biological information. To be more specific, the authenticating unit 33 determines if the information that matches the finger print pattern and/or the vein pattern is registered with the authentication information. If the information that matches the finger print pattern and/or the vein pattern is registered with the authentication information, the user who is trying to use the image forming device 1 is identified through the authentication by the authenticating unit 33, and the authentication results in success. The information that matches the feature of the user may not be registered with the user information 25. In this case, the biological authentication by the authenticating unit 33 does not enable the identification of the user, and the authentication results in failure.

When the person is detected around the image forming device 1 by the person detecting sensor 8, the authenticating unit 33 also brings the card information reader 7 into operation and waits for receiving the card information from the card information reader 7. While the authenticating unit 33 is waiting, the card information reader 7 may read the card information of the user. The authenticating unit 33 then performs the card authentication based on the card information. To be more specific, the authenticating unit 33 determines if the information read from the IC card carried by the user is registered with the authentication information. If the read information is registered with the authentication information, the user who is trying to use the image forming device 1 is identified through the authentication by the authenticating unit 33, and the authentication results in success. The information that matches the read card information may not be registered with the user information 25. In this case, the card authentication by the authenticating unit 33 does not enable the identification of the user, and the authentication results in failure.

As described above, the authenticating unit 33 performs one of the face authentication, the biological authentication, and the card authentication to identify the user who is positioned in front of the image forming device 1 and trying to use the image forming device 1. When the charging job is the copy job, a job issuing user who instructed the process of the copy job is identified through the authentication by the authenticating unit 33.

The searching unit 34 searches for the portable terminal 11 carried by the user via the communication interface 23. The searching unit 34 searches for the portable terminal 11 carried by the job issuing user from among at least one portable terminal 11 with which the communication interface 23 is establishing the connection.

It is assumed, for example, that the user is identified through the authentication by the authenticating unit 33 and the copy job is received by the job receiving unit 30. In this case, the searching unit 34 refers to the user information 25 and identifies the portable terminal 11 carried by the job issuing user identified through the authentication. The searching unit 34 searches for the portable terminal 11 of the job issuing user identified through the authentication from among the portable terminal 11 with which the connection is established by the communication interface 23. To explain more in detail, the searching unit 34 sends a search command to the portable terminal 11 with which the connection is established via the communication interface 23 and obtains responding information to the search command from the portable terminal 11. When the communication interface 23 is establishing connections with the multiple portable terminals 11, the searching unit 34 sends the search command to each of the multiple portable terminals 11 and obtain the responding information from each portable terminal 11. The responding information sent from the portable terminal 11 includes information such as a terminal ID and/or MAC address of the portable terminal 11. The searching unit 34 refers to the terminal information 26 based on the information included in the responding information received from the portable terminal 11, and searches for the portable terminal 11 carried by the job issuing user. To be more specific, the searching unit 34 searches for the portable terminal 11 carried by the user who instructed the processing of the copy job as a device the charging information of which is to be obtained.

It is assumed that the print job has already been received by the job receiving unit 30 and the user is identified through the authentication by the authenticating unit 33. In this case, the searching unit 34 determines if the job issuing user identified by the user identifying unit 31 and the user identified through the authentication match with each other. When the job issuing user identified by the user identifying unit 31 and the user identified through the authentication match with each other, the searching unit 34 refers to the user information 25 and identifies the portable terminal 11 carried by the job issuing user identified by the user identifying unit 31. The searching unit 34 searches for the portable terminal 11 of the job issuing user identified by the user identifying unit 31 from among the portable terminals 11 the connections of which are established via the communication interface 23. As well as the above-described process, the searching unit 34 sends the search command to the portable terminal 11 via the communication interface 23 and obtains the responding information from the portable terminal 11 to search for the portable terminal 11 of the job issuing user. To be more specific, the searching unit 34 searches for the portable terminal 11 carried by the job issuing user as the device from which the charging information is to be obtained. When the job issuing user identified by the user identifying unit 31 and the user identified through the authentication do not match with each other, the searching unit 34 does not search for the portable terminal 11 carried by the job issuing user identified by the user identifying unit 31. In such a case, when the user identified through the authentication by the authenticating unit 33 instructs the processing of the copy job, the portable terminal 11 carried by the user who instructed the processing of the aforementioned copy job is searched.

Once the searching unit 34 is enabled to detect the portable terminal 11 of the job issuing user through the searching process, it brings the charging information obtaining unit 35 into operation. When the portable terminal 11 of the job issuing user cannot be detected through the searching process, it is not necessary to bring the charging information obtaining unit 35 into operation.

After the portable terminal 11 of the job issuing user is detected through the searching process by the searching unit 34, the charging information obtaining unit 35 communicates with the portable terminal 11 of the job issuing user via the communication interface 23, and obtains the charging information from the portable terminal 11. Once obtaining the charging information from the portable terminal 11, the charging information obtaining unit 35 outputs the obtained charging information to the charging unit 36.

The charging unit 36 charges for the charging job based on the charging information received from the charging information obtaining unit 35. The charging unit 36, for example, specifies the charging application installed in the portable terminal 11 based on the charging information, and starts the charging application in the portable terminal 11. The charging unit 36 enables the charging application started in the portable terminal 11 to process the charging process. After the charging process is carried out in the portable terminal 11, the charging unit 36 receives a charge completion notice from the portable terminal 11. The charge completion notice includes information as to the amount of money paid in the charging process by the charging application. The charging application may be an application that carries out the electric money payment. In this case, if the balance of the electric money is the same or more than the charging amount required for the processing of the charging job, the total amount of the specified charging amount is charged normally. If the balance of the electric money is less than the charging amount required for the processing of the charging job, the total amount of the specified charging amount cannot be charged normally. In this case, the amount paid in the charging process may be less than the charging amount. The charging unit 36, therefore, determines if the paid amount included in the charge completion notice is equal to the charging amount, and is enabled to confirm if the whole amount of the charging amount is charged.

As a result of the confirmation, the all the charging amount may be charged normally. In this case, the charging unit 36 instructs the processing of the entire charging job to the job processing unit 37. The paid amount in the charging process in the portable terminal 11 may be less than the charging amount. In this case, the charging unit 36 calculates the number of the printed output that can be produced for the paid amount. The charging unit 36 then specifies the number of the printed output to be produced and instructs the processing of the part of the charging job to the job processing unit 37. The charging unit 36 displays a screen that notifies the user that the amount is short on the display unit 4a of the operational panel 4, for example. If the paid amount on the portable terminal 11 is 0 or the charging process results in failure in the portable terminal 11, the charging unit 36 restricts the job processing unit 37 to process the charging job.

The job processing unit 37 is a controller that controls the printer section 3 to enable the printer section 3 to produce the printed output based on the charging job. As described above, when the total amount of the charging amount is charged normally, the job processing unit 37 processes the entire charging job to complete producing the printed output based on the instruction from the charging unit 36. When the paid amount in the charging process is less than the charging amount, the job processing unit 37 produces the specified number of printed outputs by the charging unit 36. To be more specific, the job processing unit 37 only processes a part of the charging job and suspends the processing of rest of the charging job. The suspended charging job is processed when rest of the amount is paid by the user.

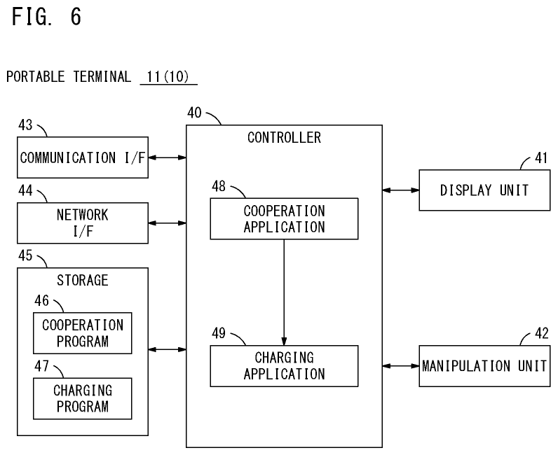

FIG. 6 illustrates a block diagram showing an exemplary hardware structure and functional structure of the portable terminal 11. The portable terminal 11 is constructed by a portable device such as a smartphone or a tablet terminal, for example. As its hardware structure, the portable terminal 11 is provided with a controller 40, a display unit 41, a manipulation unit 42, a communication interface 43, a network interface 44 and a storage 45.

The controller 40 includes a CPU and a memory which are not shown in FIG. 6. The controller 40 executes a variety of programs to control operations of each processing unit. The display unit 41 is constructed by a device such as a color liquid crystal display, for instance. A variety of images are displayed on the display unit 41. The manipulation unit 42 is constructed by a part such as a touch panel key arranged on the screen of the display unit 41. The manipulation unit 42 receives an input by the user. The communication interface 43 is an interface that establishes wireless communication by Bluetooth (trademark), for example. The communication interface 43 establishes a connection with another device (for instance, the image forming device 1) which is within a predetermined distance of the portable terminal 11, and makes the wireless communication. The network interface 44 is an interface that establishes wireless communication by WiFi. The network interface 44 connects to the network such as LAN via an access point of WiFi and communicates with another device (for instance, the image forming device 1). The storage 45 is a nonvolatile storage formed from a solid-state drive (SSD), for example.

A cooperation program 46 and a charging program 47 are stored in advance in the storage 45. The cooperation program 46 is to enable the portable terminal 11 to work together with the image forming device 1. The charging program 47 is to enable the portable terminal 11 to carry out the charging process.

The CPU of the controller 40 executes the cooperation program 46 to start a cooperation application 48 of the controller 40. The cooperation application 48 is a resident application of the controller 40 that performs operations in cooperation with the image forming device 1. The CPU of the controller 40 executes the charging program 47 to start a charging application 49 of the controller 40. The charging application 49 carries out the charging process in a predetermined payment method such as an electric money payment, a credit card payment, or a payment of direct withdrawal from a bank account.

When the cooperation application 48 which is resident in the controller 40 receives the search command from the searching unit 34 of the image forming device 1, it sends the responding information including the terminal ID and/or the MAC address of the portable terminal 11 to the image forming device 1. The searching unit 34 of the image forming device 1 is enabled to determine if the responding information is sent by the portable terminal 11 of the job issuing user based on the responding information received from the cooperation application 48. Once receiving a charging information request from the image forming device 1, the cooperation application 48 sends the charging information including information relating to the charging application 49 to the image forming device 1. As a result, the image forming device 1 is enabled to identify the charging application 49 installed in the portable terminal 11. After sending the charging information, the cooperation application 48 may receive an order to start the charging application 49. In this case, the cooperation application 48 starts the charging application 49 in the portable terminal 11. After starting the charging application 49, the cooperation application 48 may receive a charging order from the image forming device 1. The cooperation application 48 then specifies the charging amount based on the charging order and enables the charging application 49 to carry out the charging process. When the charging process by the charging application 49 completes, the cooperation application 48 sends the charge completion notice to the image forming device 1. As described above, the portable terminal 11 is constructed to enable the charging application 40 to automatically carry out the charging process using the function of the cooperation application 48 that works together with the image forming device 1.

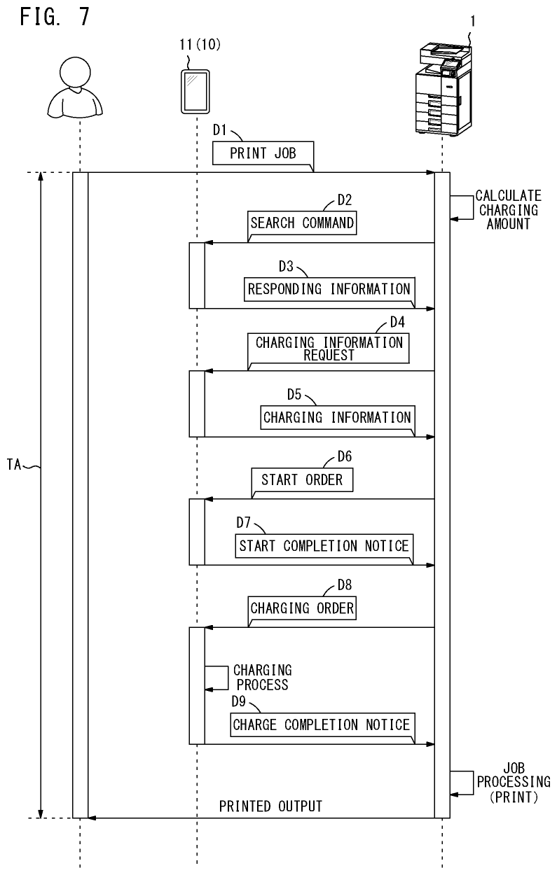

FIG. 7 illustrates an exemplary main flow of the cooperation operation between the image forming device 1 and the portable terminal 11. In the example of FIG. 7, the charging job is a print job as an example. When the user uses his or her information processing device to send a print job D1 to the image forming device 1, the image forming device 1 receives the print job D1 as the charging job, and calculates the charging amount to the job issuing user. The image forming device 1 sends a search command D2 to search for the portable terminal 11 that is around the device and carried by the job issuing user. The image forming device 1 repeatedly sends the search command D2 at intervals of predetermined period until the portable terminal 11 carried by the job issuing user is found.

Once the job issuing user comes closer to the predetermined distance around the image forming device 1 while carrying his or her portable terminal 11, the portable terminal 11 receives the search command D2 from the image forming device 1. The portable terminal 11 then sends the responding information including the terminal ID and/or the MAC address to the image forming device 1.

After the image forming device 1 detects the portable terminal 11 of the job issuing user based on the responding information received from the portable terminal 11, it designates the portable terminal 11 as a target from which the charging information is to be obtained. The image forming device 1 sends a charging information request D4 to the portable terminal 11 of the job issuing user. The portable terminal 11 receives the charging information request D4 from the image forming device 1, and generates charging information D5 including the information relating to the charging application 49. The portable terminal 11 sends the generated charging information D5 to the image forming device 1.

The image forming device 1 identifies the charging application 49 which performs the charging process in the portable terminal 11 based on the charging information D5 received from the portable terminal 11 of the job issuing user. The image forming device 1 sends a start order D6 to start the charging application 49 to the portable terminal 11. The portable terminal 11 starts the charging application 49 based on the start order D6 from the image forming device 1. After starting the charging application 49, the portable terminal 1 sends a start completion notice D7 to the image forming device 1.

After confirming that the charging application 49 is started based on the start completion notice D7, the image forming device 1 sends a charging order D8 that includes a charging amount to the portable terminal 11. In response to receiving the charging order D8 from the image forming device 1, the portable terminal 11 enables the charging application 49 to carry out the charging process. Through the charging process, a part of or all the charging amount required for the processing of the charging job is paid. After completing the charging process by the charging application 49, the portable terminal 11 sends a charge completion notice D9 to the image forming device 1. The charge completion notice D9 includes the paid amount paid in the charging process. The image forming device 1 is enabled to determine if all the charging amount is charged based on the paid amount included in the charge completion notice D9. Once determining that all the charging amount is charged, the image forming device 1 produces a printed output based on the print job D1 and provides the job issuing user with the printed output.

In the first embodiment, the image forming device 1 and the portable terminal 11 automatically work together to automatically carry out the charging process corresponding to the charging amount for the processing of the charging job as described above, and produces the printed output based on the charging job. The user is not necessary to operate the portable terminal 11 during a period TA after sending the print job D1 to the image forming device 1 to receiving the printed output from the image forming device 1. Hence, even still the user puts the portable terminal 11 in a pocket of his or her clothes, for example, he or she does not need to take out the portable terminal 11 to operate and can get the printed output.

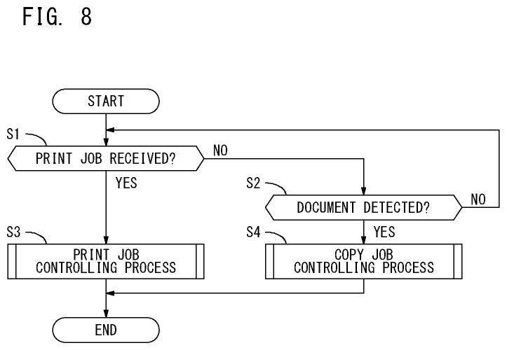

A process sequence performed in the above-described image forming device 1 is explained next. FIG. 8 illustrates an example of a flow diagram explaining an exemplary procedure of the process performed in the image forming device 1. This process is repeatedly performed when the CPU 20a of the controller 40 of the image forming device 1 executes the program 24. In the example of FIG. 8, the image forming device 1 receives the print job and the copy job as charging jobs.

Upon start of the process, the image forming device 1 determines if the print job is received (step S1). If the print job is not received (when a result of step S1 is NO), the image forming device 1 determines if the placement of the document on the scanner section 2 is detected (step S2). The placement of the document is not detected (when a result of step S2 is NO), the process by the image forming device 1 returns to step S1 to repeat the above-described determination.

In response to receiving the print job (when a result of step S1 is YES), the image forming device 1 carries out a print job controlling process (step S3). After detecting that the document is placed on the scanner section 2 (when a result of step S2 is YES), the image forming device 1 carries out a copy job controlling process (step S4).

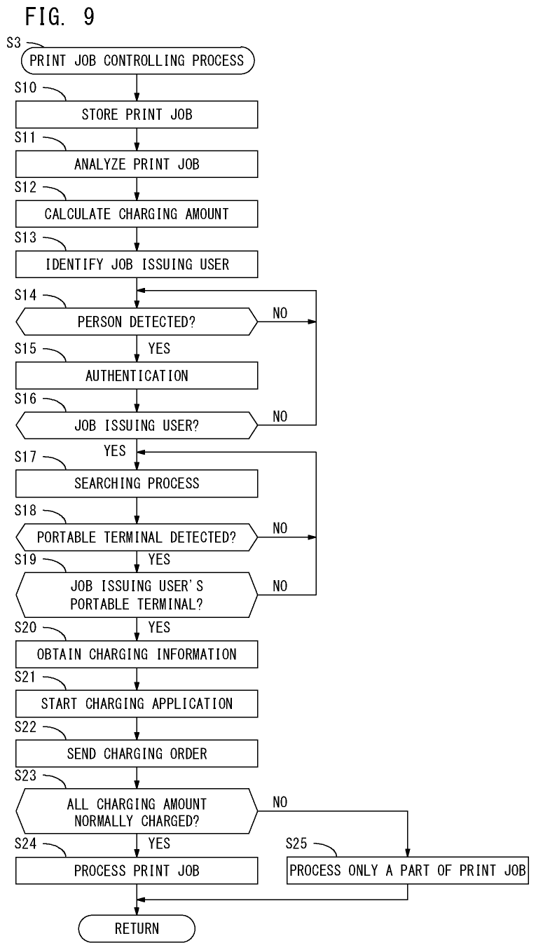

FIG. 9 illustrates a flow diagram explaining an exemplary procedure of the print job controlling process (step S3) in detail. After starting the print job controlling process, the image forming device 1 stores the received print job (step S10). To be more in detail, because the image forming device 1 receives the print job as the charging job, it holds the production of the printed output based on the print job until the charging process is carried out. After storing the print job, the image forming device 1 analyzes the print job (step S11), and calculates the charging amount based on the print settings (step S12). The image forming device 1 refers to the header information of the print job to identify the job issuing user of the print job (step S13). The image forming device 1 then waits until a person who exists within the certain distance in front of the image forming device 1 is detected by the person detecting sensor 8 (when a result of step S14 is NO).

When the person is detected by the person detecting sensor 8 (when a result of step S14 is YES), the image forming device 1 performs the authentication (step S15). In the authentication, at least one of the face authentication, the biological authentication and the card authentication is performed so that the user who is in front of the image forming device 1 is identified. The image forming device 1 then determines if the user authenticated in the authentication is the job issuing user. The authenticated user may not be the job issuing user (when a result of step S16 is NO). In this case, the process by the image forming device 1 returns to the process in step S14.

The user authenticated in the authentication may match with the job issuing user (when a result of step S16 is YES). In this case, the image forming device 1 starts a searching process (step S17). To be more specific, the image forming device 1 sends the search command D2 to the portable terminal 11 via the communication interface 23, and searches for the portable terminal 11 carried by the job issuing user. The image forming device 1 determines if the portable terminal 11 is successfully detected (step S18). When the portable terminal 11 is detected successfully (when a result of step S18 is YES), the image forming device 1 determines if the detected portable terminal 11 is carried by the job issuing user (step S19). If the portable terminal 11 is not detected (when a result of step S18 is NO), or the detected portable terminal 11 is not owned by the job issuing user (when a result of step S19 is NO), the process by the image forming device 1 returns to the process in step S17 to repeat the searching process.

When the portable terminal 11 of the job issuing user is successfully detected (when a result of step S19 is YES), the image forming device 1 sends the charging information request D4 to the job issuing user's portable terminal 11, and obtains the charging information D5 from the portable terminal 11 (step S20). The image forming device 1 identifies the charging application 49 in which the charging process is carried out on the portable terminal 11 based on the charging information D5. The image forming device 1 sends the start order D6 that specifies the charging application 49 that should be start in the portable terminal 11 to start the charging application 49 (step S21). In response to receiving the start completion notice D7 from the portable terminal 11, the image forming device 1 detects that the charging application 49 is started. After the detecting that the charging application 49 is started, the image forming device 1 sends the charging order D8 including the charging amount to the portable terminal 11 (step S22). To be more specific, the image forming device 1 enables the charging application 49 in the portable terminal 11 to carry out the charging process. The image forming device 1 then receives the charge completion notice D9 from the portable terminal 11. In response to receiving the charge completion notice D9, the image forming device 1 determines if all the charging amount is normally charged (step S23). If all the amount is charged (when a result of step S23 is YES), the image forming device 1 drives the printer section 3 to produce the printed out based on the print job (step S24).

Not all but only a part of the charging amount is charged (when a result of S23 is NO), the image forming device 1 processes only a part of the print job (step S25). To be more specific, the image forming device 1 calculates the number of the sheet that can be produced based on the paid amount through the charging process, and processes the print job up to the number of the produced sheet reaching the calculated number. The image forming device 1 suspends the process of the print job at the time that the number of the produced sheet reaches the calculated number. The image forming device 1 then holds again the processing of rest of the print job.

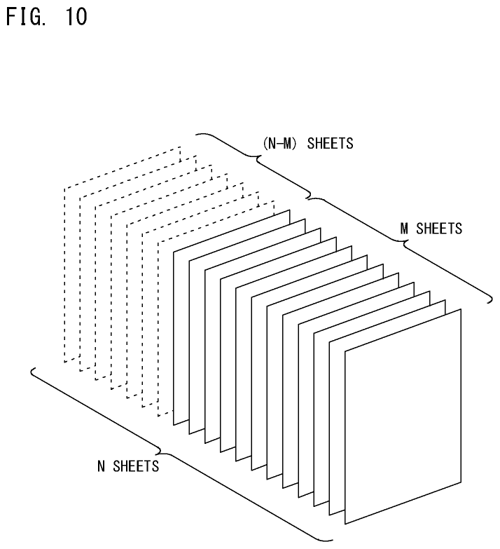

FIG. 10 illustrates an example the number of the produced printed output when the paid amount does not reach the charging amount in the charging process. As illustrated in FIG. 10, it is assumed that the number of the sheet produced based on the print job is N and the number of the sheet equivalent to the paid amount is M (M<N). In this case, the image forming device 1 produces M sheets by processing the print job. The rest of the sheet (N-M) is not produced and will be hold. Hence, the present invention is enabled to prevent the entire print job to be processed when the paid amount does not reach the charging amount.

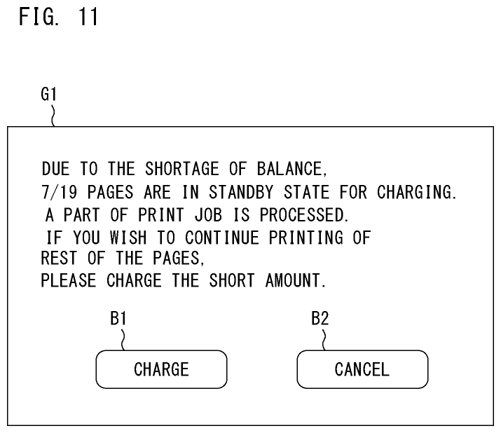

As described above, the image forming device 1 notifies the user that the amount is short when it only processes a part of the print job. FIG. 11 illustrates an example of a notification screen G1 displayed on the display unit 4a of the image forming device 1. The notification screen G1 displays a message that notifies that the charging amount is short, only a part of the print job is processed and the charging process for the short amount is necessary in order to process rest of the print job. The notification screen G1 is displayed on the display unit 4a of the operational panel 4 so that the user can find out that the charging amount is short without taking his or her portable terminal 11 out.

A charging process button B1 and a cancel button B2 are displayed in the notification screen G1. The user operates the charging process button B1 to charge the short amount. In this case, the image forming device 1 obtains the operation screen being displayed on the display unit 41 by the charging application 49 via the cooperation application 48 in the portable terminal 11, for example, and displays the operation screen on the display unit 4a of the operational panel 4. In response to detecting the user operation to the operation screen, the image forming device 1 sends information relating to the operation (hereafter, operation information) to the portable terminal 11 to provide the information with the charging application 49 via the cooperation application 48. As a result, the user is enabled to carry out the charging process corresponding to the short amount with the operation to the operational panel 4 without taking his or her portable terminal 11 out. The cancel button B2 is for the user to cancel the processing of rest of the print job.

Once the charging process for the short amount is carried out by the user, the image forming device 1 releases the holding of rest of the print job and restarts the processing. The entire print job is processed and the user is enabled to obtain the full printed output.

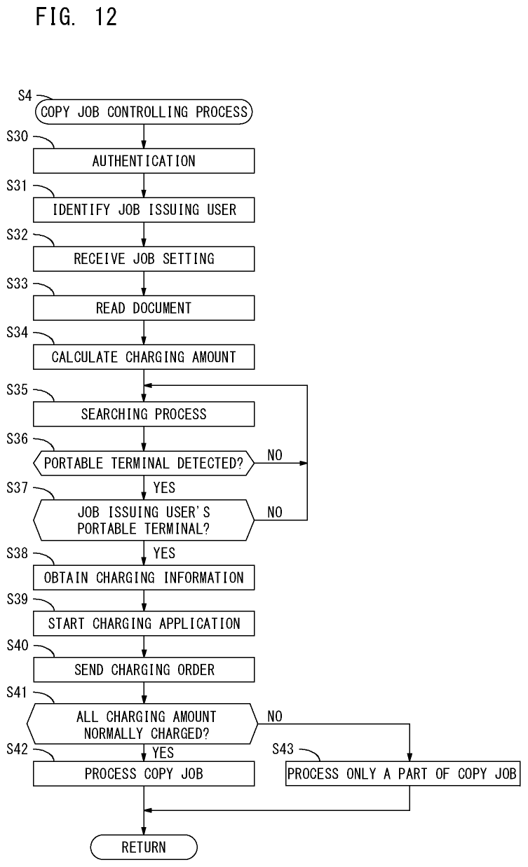

FIG. 12 illustrates a flow diagram explaining an exemplary procedure of the copy job controlling process (step S4) in detail. After starting the copy job controlling process, the image forming device 1 carries out the authentication (step S15). At least one of the face authentication, the biological authentication and the card authenticating is carried out in the authentication. The user in front of the image forming device 1 is identified as the job issuing user. The image forming device 1 receives the job setting operation by the user (step S32). When the start of the processing of the job is instructed by the user, the image forming device 1 starts reading the document (step S33). After finishing the reading operation of all the documents placed by the user, the image forming device 1 calculates the charging amount based on the job settings (step S34).

The image forming device 1 then runs a search to search for the portable terminal 11 of the job issuing user (step S35). To be more specific, the image forming device 1 sends the search command D2 to the portable terminal 11 via the communication interface 23, and determines if the portable terminal 11 is detected based on responding information D3 from the portable terminal 11 (step S36). When the portable terminal 11 is detected (when a result of step S36 is YES), the image forming device 1 further determines if the portable terminal 11 is carried by the job issuing user (step S37).

When the portable terminal 11 carried by the job issuing user is detected (when a result of step S37 is YES), the image forming device 1 sends the charging information request D4 to the portable terminal 11 of the job issuing user, and obtains the charging information D5 from the portable terminal 11 (step S38). The image forming device 1 sends the start order D6 that specifies the charging application 49 to start in the portable terminal 11 to the portable terminal 11 based on the charging information D5 to start the charging application 49 (step S39). The image forming device 1 receives the start completion notice D7 from the portable terminal 11 and detects that the charging application 49 is started. After detecting, the image forming device 1 sends the charging order D8 including the charging amount to the portable terminal 11 (step S40). In response to receiving the charge completion notice D9 from the portable terminal 11, the image forming device 1 determines if the charging process for all the charging amount is normally carried out (step S41). The charging process for all the charging amount may be normally carried out (when a result of step S41 is YES). In this case, the image forming device 1 drives the printer section 3 to produce all the printed outputs based on the copy job (step S42).

Not all but only a part of the charging amount may be charged (when a result of step S41 is NO). In this case, the image forming device 1 produces only a part of the printed outputs included in the copy job (step S43). The detailed operation in this case is the same as that for the print job.

As described above, when receiving the charging job such as the print job or the copy job, the image forming device 1 searches for the charging information storage 10 around the device, and obtains the charging information D5 from the charging information storage 10 detected by the search. The image forming device 1 carries out the charging process for the charging job, and processes the charging job based on the charging information D5 obtained from the charging information storage 10. The charging information storage 10 of the first preferred embodiment is formed from the portable terminal 11 carried by the user. The image forming device 1 searches for the portable terminal 11 around the device via the communication interface 23, and obtains the charging information from the portable terminal 11 detected by the search.

As described above, even still the user is putting the portable terminal 11 in his or her clothes' pocket, he or she does not have to take the portable terminal 11 out. The charging process is automatically carried out, and the user can obtain the printed output produced by the image forming device 1. Even when the user carries luggage in both hands, he or she does not need to put the luggage on the floor. The user can get and take the printed output away with holding the luggage in both hands, resulting in enhanced convenience compared to the conventional technique.

### Second Embodiment

The second embodiment of the present invention is explained next. The charging information storage 10 of the above-described first embodiment is the portable terminal 11. The charging information storage 10 of the second embodiment is a display member that simply displays the charging information.

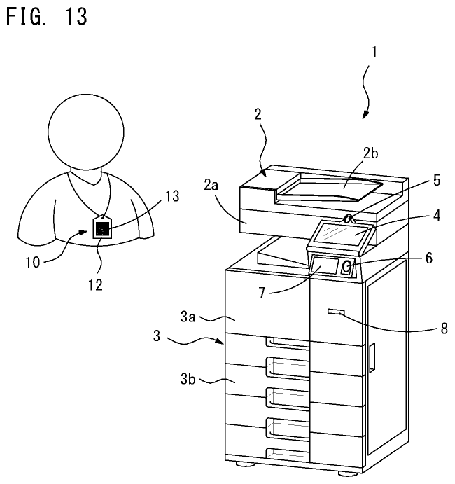

FIG. 13 illustrates an exemplary structure of the image forming device 1 in which the second embodiment of the present invention may be practiced. The image forming device 1 of the second embodiment is the same as that of the first embodiment. The only difference between the image forming device 1 of the second embodiment and that of the first embodiment is that the searching unit 34 searches for the billing information storage 10.

In the second embodiment, the user carries a display member 12 on which a code 13 is displayed on him or her. The code 13 shows the charging information D5 in a two-dimensional barcode such as a QR code (trademark). The display member 12 of the second embodiment corresponds to the charging information storage 10. The display member 12 can be a simple plate or a sheet such as a printed paper on which the code 13 is printed. The display member 12 may be the portable terminal 11 the same as that of the first embodiment and the code 13 may be displayed on the display unit 41 of the portable terminal 11. The user carries the display member 12 in a way that the code 13 displayed on the display member 12 can be seen from outside. As illustrated in FIG. 13, the user puts the display member 12 around his or her neck to carry the display member 12, for example.

The charging information D5 shown in the code 13 includes information to carry out the charging process to charge the user. The charging information D5, for example, includes information to carry out the charging process using the electronic money charged in advance by the user. If the charging information D5 is extracted by analyzing the code 13, the image forming device 1 is enabled to carry out the charging process.

In order to search for the charging information storage 10 from which the charging information is obtained after receiving the charging job, the image forming device 1 drives the camera 5 to photograph an image around the image forming device 1. The image photographed by the camera 5 may be a still image or a video. The image forming device 1 analyzes the image photographed by the camera 5, and determines if the code 13 is shown in the image. When the code 13 is shown in the image, the image forming device 1 analyzes the code 13 to obtain the charging information D5 from the image. The image forming device 1 carries out the charging process to charge the charging amount for the processing of the charging job based on the charging information D5.

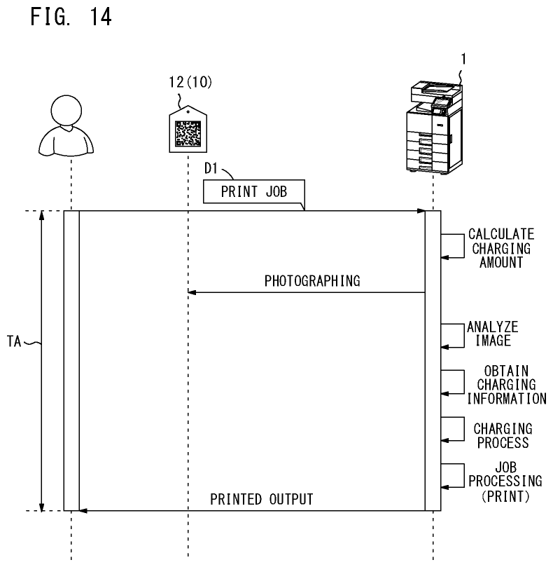

FIG. 14 illustrates an exemplary main flow of the operations of the image forming device 1 of the second embodiment. In the example of FIG. 14, the charging job is a print job as an example. When the user uses his or her information processing device to send the print job D1 to the image forming device 1, the image forming device 1 receives the print job D1 as the charging job, and calculates the charging amount on the job issuing user. The image forming device 1 drives the camera 5 and starts photographing the display member 12 around the device. The image forming device 1 obtains the image photographed by the camera 5, and analyzes the image. The image forming device 1 then obtains the charging information D5. After obtaining the charging information D5, the image forming device 1 carries out the charging process based on the charging information D5. The image forming device, for example, accesses a server that processes a payment of the user's the electronic money via the network interface 22, and sends a charging request to the server so that the charging process is carried out. Through the charging process, a part or all the charging amount required for the processing of the charging job is paid. The image forming device 1 determines if all the charging amount is successfully charged. When determining all the charging amount is successfully charged, the image forming device 1 produces the printed output based on the print job D1 and provides the job issuing user with the printed output.

The image forming device 1 of the second embodiment operates in the above-described manner to automatically carry out the charging process corresponding to the charging amount required for the processing of the charging job and produces the printed output based on the charging job. Thus, the user is not required to operate the portable terminal 11 in the period TA which is after he sends the print job D1 to the image forming device 1 until he receives the printed output from the image forming device 1. Hence, even still the user puts his or her portable terminal 11 in the pocket of the clothes, for example, he or she doesn't have to take the portable terminal 11 out or operate to obtain the produced printed output.

A process sequence performed in the above-described image forming device 1 is explained next. The exemplary main procedure of the process performed by the image forming device 1 of the second embodiment is the same as that of the first embodiment explained in the flow diagram of FIG. 8. The detailed process of the print job controlling process (step S3) and the copy job controlling process (step S4) is different from that explained in the first embodiment. The detailed process of the print job controlling process (step S3) and the copy job controlling process (step S4) of the second embodiment is explained next.

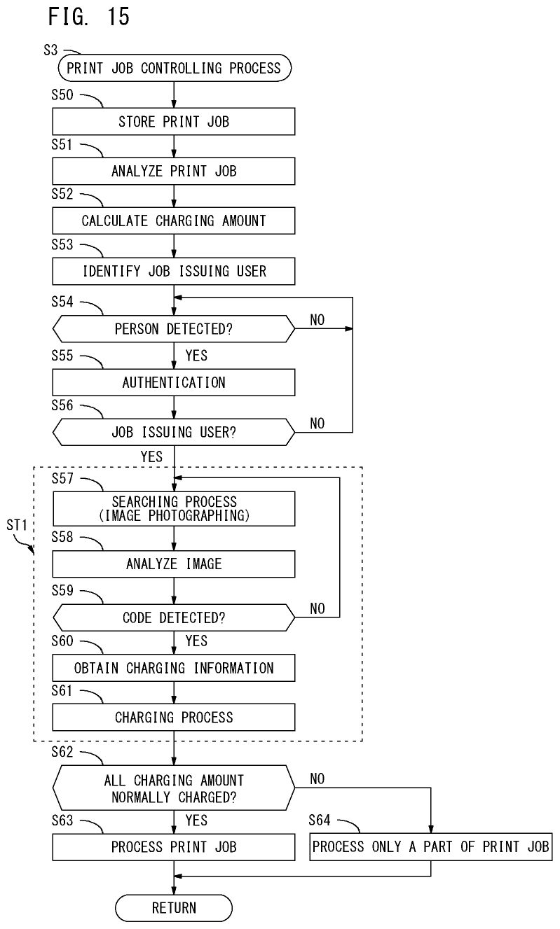

FIG. 15 illustrates a flow diagram explaining an exemplary procedure of the print job controlling process (step S3) of the second embodiment in detail. The process in steps S50 to S56 of FIG. 15 is the same as that in steps S10 to S16 of FIG. 9, and the process in steps S62 to S64 of FIG. 15 is the same as that in steps S23 to S25 of FIG. 9. To be more specific, the characteristic of the procedure of the process of the second embodiment is a process ST1 with a broken-line frame in the example of FIG. 15. The distinctive process ST1 is explained next.

When the image forming device 1 determines that the user authenticated in the authentication matches with the job issuing user (when a result of step S56 is YES), it starts the searching process (step S57). The image forming device 1 drives the camera 5, and starts photographing the image around the image forming device 1. The image forming device 1 analyzes the image obtained from the camera 5 (step S58), and determine if an image element of the code 13 including the charging information D5 is detected from the image (step S59). The image element of the code 13 may not be detected (when a result of step S59 is NO). In this case, the image forming device 1 returns to the process in step S57 to repeat photographing the image. When the image element of the code 13 is detected (when a result of step S59 is YES), the image forming device 1 analyzes the code 13 to obtain the charging information D5 (step S60). To be more specific, the image forming device 1 obtains the charging information D5 from the image photographed by the camera 5. The image forming device 1 carries out the charging process based on the charging information D5 obtained from the image photographed by the camera 5 (step S61). The process performed by the image forming device 1 proceeds to step S62 to perform the same process as that explained in the first embodiment.

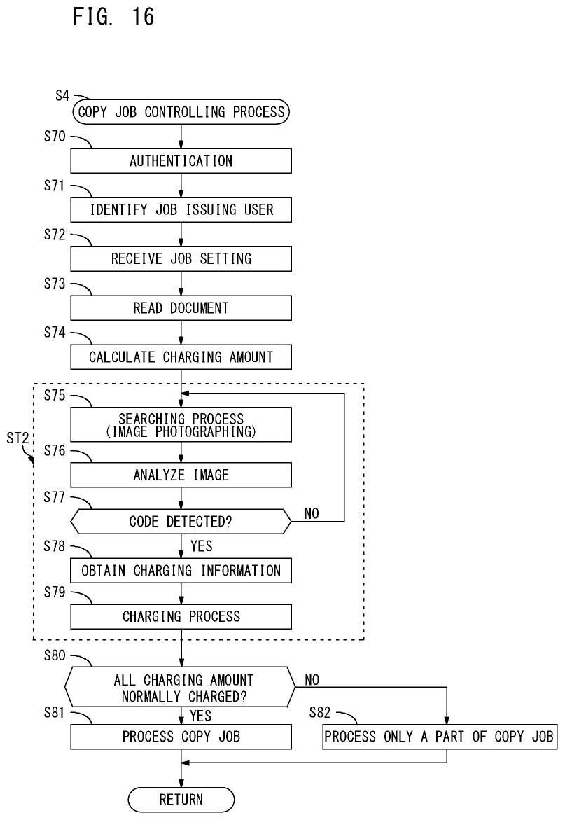

FIG. 16 illustrates a flow diagram explaining an exemplary procedure of the copy job controlling process (step S4) of the second embodiment in detail. The process in steps S70 to S74 of FIG. 16 is the same as that in steps S30 to S34 of FIG. 12, and the process in steps S80 to S82 of FIG. 16 is the same as that in steps S41 to S43 of FIG. 9. To be more specific, the characteristic of the procedure of the process of the second embodiment is a process ST2 with a broken-line frame in the example of FIG. 16. The distinctive process ST2 is explained next.

After calculating the charging amount for the processing of the copy job (step S74), the image forming device 1 starts the searching process (step S75). The image forming device 1 drives the camera 5, and starts photographing the image around the image forming device 1. The image forming device 1 analyzes the image obtained from the camera 5 (step S76), and determines if the image element of the code 13 including the charging information D5 is detected from the image (step S77). The image element of the code 13 may not be detected (when a result of step S77 is NO). In this case, the image forming device 1 returns to the process in step S75 to repeat photographing the image. When the image element of the code 13 is detected (when a result of step S77 is YES), the image forming device 1 analyzes the code 13 to obtain the charging information D5 (step S78). To be more specific, the image forming device 1 obtains the charging information D5 from the image photographed by the camera 5. The image forming device 1 carries out the charging process based on the charging information D5 obtained from the image photographed by the camera 5 (step S79). The process performed by the image forming device 1 proceeds to step S80 to perform the same process as that explained in the first embodiment.

As described above, when receiving the charging job such as the print job or the copy job, the image forming device 1 of the second embodiment, the same as the first embodiment, searches for the charging information storage 10 around the device, and obtains the charging information D5 from the charging information storage 10 detected in the search. The image forming device 1 carries out the charging process for the charging job, and processes the charging job based on the charging information D5 obtained from the charging information storage 10. The charging information storage 10 of the first embodiment is formed from the display member 12 on which the charging information D5 is displayed. The image forming device 1 drives the camera 5 to photograph the image around the device, and obtains the charging information D5.

As described above, even still the user is putting the portable terminal 11 in his or her clothes' pocket, he or she does not have to take the portable terminal 11 out. The charging process is automatically carried out, and the user can obtain the printed output produced by the image forming device 1. Even when the user carries luggage in both hands, he or she does not need to put the luggage on the floor and can get and take the printed output away with holding the luggage in both hands, resulting in enhanced convenience compared to the conventional technique.

The structures and operations of the image forming device 1 of the second embodiment are the same as those explained in the first embodiment except for the above-described structure and operation.

Although embodiments of the present invention have been described and illustrated in detail, the disclosed embodiments are made for purposes of illustration and example only and not limitation. The scope of the present invention should be interpreted by terms of the amended claims.

### (Modifications)

While the first and second embodiment of the present invention have been described above, the present invention is not limited to the embodiments. Various modifications may be applied to the present invention.

The image forming device 1 of the above-described embodiments is constructed by one of MFPs that has multiple functions such as a copy function and/or a print function. However, this is given not for limitation. The image forming device 1 does not always have to have multiple functions. The image forming device 1 may be a copier that only includes the copy function or a printer that only includes the print function.

Three ways of the authentication including the face authentication, the biological authentication and the card authentication are given as an example of authenticating the user. A way of determining if a combination of an ID and a password input by the user matches with a combination registered in advance can be used for the way of the authentication.

In the above-described embodiments, for example, the image forming device 1 searches for the charging information storage 10 around the device when the authentication to authenticate the user results in success. The timing that the image forming device 1 searches for the charging information storage 10 around the device does not always have to be after the authentication results in success. It is assumed, for example, the user operates his or her information processing device to send the print job to the image forming device 1, he or she moves to the installation site of the image forming device 1 to obtain the printed output. Once the portable terminal 11 of the user is placed within the certain distance, the image forming device 1 automatically establishes the communicable connection. Thus, the image forming device may send the search command D2 to the portable terminal 11 at the time that the communicable connection is established with the portable terminal 11, and searches if it is the portable terminal 11 of the job issuing user.

In the above-described embodiments, the program 24 executed in the image forming device 1 is installed in advance. However, this is given not for limitation. The program 24 may be installed at any time. In this case, the program 24 may be provided over a network in a manner that enables a user to download. The program 24 may also be provided in a manner that is recorded on a computer readable recording medium such as a CD-ROM, a DVD-ROM, or a USB memory.

What is claimed is:

1. An image forming device, comprising a hardware processor that:
receives a charging job that is an object of charging;
searches for a charging information storage that is around the device when the charging job is received;
obtains charging information from the searched charging information storage;
carries out a charging process for the charging job based on the charging information; and
processes the charging job after the charging process is carried out.

2. The image forming device according to claim 1, wherein
the charging information storage is a portable terminal carried by a user,
the image forming device further comprises a communication part that communicates with the portable terminal, and
the hardware processor that:
searches for the portable terminal that is around the device via the communication part; and
obtains the charging information from the searched portable terminal via the communication part.

3. The image forming device according to claim 2, further comprising:
a storage in which terminal information that makes the portable terminal correspondent to the user who carries the portable terminal, wherein
the hardware processor further identifies a job issuing user who issued the charging job when the charging job is received, and
when the job issuing user is identified, the hardware processor searches for the portable terminal carried by the job issuing user based on the terminal information.

4. The image forming device according to claim 3, wherein
the communication part establishes a connection that enables automatic communication with the portable terminal within a predetermined distance, and
the hardware processor searches for the portable terminal carried by the job issuing user from among at least one portable terminal with which the communication part is establishing the connection.

5. The image forming device according to claim 3, wherein
the hardware processor further authenticates the user who is around the device, and
the hardware processor identifies the job issuing user based on a result of the authentication.

6. The image forming device according to claim 3, wherein
the hardware processor further authenticates the user who is around the device, and
when the authenticated user and the identified job issuing user are the same user, the hardware processor searches for the portable terminal carried by the job issuing user.

7. The image forming device according to claim 5, further comprising:
a photographing part that photographs an image of the user, wherein
the hardware processor performs a face authentication based on the image photographed by the photographing part.

8. The image forming device according to claim 5, further comprising:
a biological information obtaining part that obtains biological information of the user, wherein
the hardware processor performs a biological authentication based on the biological information obtained by the biological information obtaining part.

9. The image forming device according to claim 5, further comprising:
a card information reader that reads card information stored in an IC card, wherein
the hardware processor performs a card authentication based on the card information obtained by the card information reader.

10. The image forming device according to claim 2, wherein
the hardware processor that:
obtains information relating to a charging application installed in the portable terminal as the charging information through communication with the portable terminal; and
starts the charging application in the portable terminal based on the charging information and sends a charging order to the charging application to carry out the charging process.

11. The image forming device according to claim 1, further comprising:
a photographing part that photographs an image around the device, wherein
the hardware processor that:
searches for an image element of the charging information storage from the image obtained by enabling the photographing part to photograph around the device; and
obtains the charging information from the searched image element of the charging information storage.

12. The image forming device according to claim 1, wherein
the hardware processor completes processing of the charging job when all a charging amount for the charging job is charged in the charging process.

13. The image forming device according to claim 1, wherein
the hardware processor processes only a part of the charging job when all the charging amount for the charging job is not charged in the charging process.

14. The image forming device according to claim 1, wherein
the hardware processor notifies the user that the amount is short when all the charging amount for the charging job is not charged in the charging process.

15. A charging method applied in an image forming device, comprising:
receiving a charging job that is an object of charging;
searching for a charging information storage that is around the device when the charging job is received;
obtaining charging information from the searched charging information storage;
carrying out a charging process for the charging job based on the charging information; and
processing the charging job after the charging process is carried out.

16. The charging method according to claim 15, wherein
the charging information storage is a portable terminal carried by a user,
the image forming device comprises a communication part that communicates with the portable terminal, and
the method further comprising:
searching for the portable terminal that is around the device via the communication part; and
obtaining the charging information from the searched portable terminal via the communication part.

17. The charging method according to claim 16, further comprising:
storing terminal information that makes the portable terminal correspondent to the user who carries the portable terminal; and
identifying a job issuing user who issued the charging job when the charging job is received, wherein
when the job issuing user is identified, the portable terminal carried by the job issuing user is searched based on the terminal information.

18. The charging method according to claim 17, wherein
the communication part establishes a connection that enables automatic communication with the portable terminal within a predetermined distance, and
the portable terminal carried by the job issuing user is searched from among at least one portable terminal with which the communication part is establishing the connection.

19. The charging method according to claim 17, further comprising:
authenticating the user who is around the device, wherein
the job issuing user is identified based on a result of the authentication.

20. The charging method according to claim 17, further comprising:
authenticating the user who is around the device, wherein
when the authenticated user and the identified job issuing user are the same user, the portable terminal carried by the job issuing user is searched.

21. The charging method according to claim 19, wherein
the image forming device further comprises a photographing part that photographs an image of the user, and
a face authentication is performed based on the image photographed by the photographing part.

22. The charging method according to claim 19, wherein
the image forming device further comprises a biological information obtaining part that obtains biological information of the user, and
a biological authentication is performed based on the biological information obtained by the biological information obtaining part.

23. The charging method according to claim 19, wherein
the image forming device further comprises a card information reader that reads card information stored in an IC card, and
a card authentication is performed based on the card information obtained by the card information reader.

24. The charging method according to claim 16, wherein
information relating to a charging application installed in the portable terminal is obtained as the charging information through communication with the portable terminal, and
the charging application in the portable terminal is started based on the charging information and a charging order is sent to the charging application so that the charging process is carried out.

25. The charging method according to claim 15, wherein
the image forming device further comprises a photographing part that photographs an image around the device, and
an image element of the charging information storage is searched from the image obtained from the photographing part that is enabled to photograph around the device in the search for the charging information storage, and
the charging information is obtained from the searched image element of the charging information storage.

26. The charging method according to claim 15, wherein
processing of the charging job is completed when all a charging amount for the charging job is charged in the charging process.

27. The charging method according to claim 15, wherein
only a part of the charging job is processed when all the charging amount for the charging job is not charged in the charging process.

28. The charging method according to claim 15, wherein
the user is notified that the amount is short when all the charging amount for the charging job is not charged in the charging process.

29. A non-transitory recording medium storing a computer readable program to be executed by a hardware processor in an image forming device, wherein the computer readable program causes the hardware processor executing the computer readable program to:
receive a charging job that is an object of charging;
search for a charging information storage that is around the device when the charging job is received;
obtain charging information from the searched charging information storage;
carry out a charging process for the charging job based on the charging information; and
process the charging job after the charging process is carried out.
